(19) United States
(12) Patent Application Publication
(10) Pub. No.: US 2009/0234667 A1
(43) Pub. Date: Sep. 17, 2009

(54) SYSTEMS AND METHODS FOR ENABLING COLLABORATION AND COORDINATION OF SUPPORT

(76) Inventor: Timmy R. Thayne, Lehi, UT (US)

Correspondence Address: David B. Tingey, 1800 Eagle Gate Tower, 60 East South Temple, Salt Lake City, UT, 84145, US

(21) Appl. No.: 12/340,332

(22) Filed: Dec. 19, 2008

Related U.S. Application Data
(60) Provisional application No. 61/015,165, filed on Dec. 19, 2007.

(51) Int. Cl. G06Q 99/00; G06F 7/00; G06F 17/30

(52) U.S. Cl. 705/1; 707/9; 707/102; 707/E17.044; 707/E17.009

(57) ABSTRACT

The present invention relates to systems and methods for enabling collaboration and coordination of support within a controlled electronic environment. In particular, embodiments of the present invention relate to a dynamic, collaborative, and online support system that integrates assessment functionality, data reporting, communication tools, calendaring, and specific curriculum, with the power of an online community support system devoted specifically to helping an individual maintain and/or improve from a current level of functioning to a higher level of functioning. Further, embodiments of the present invention embrace systems and methods for selectively distributing sensitive information in a timely and controlled manner to key people, organizations, and professionals, who are in positions to support a particular individual, family, or group, and wherein the information is provided based on the positive impact/influence each can provide based on given circumstances.

### CROSS-REFERENCE TO RELATED APPLICATION

This application claims the benefit of U.S. Provisional Patent Application 60/015,165, entitled SYSTEMS AND METHODS FOR ENABLING COLLABORATION AND COORDINATION OF SUPPORT, filed on Dec. 19, 2007, the entire disclosure of which is incorporated herein by reference.

### BACKGROUND OF THE INVENTION

1. Field of the Invention

The present invention relates to collaboration and coordination of support. In particular, embodiments of the present invention relate to integrating and enabling assessment functionality, data reporting, communication tools, calendaring, and specific curriculum, along with the power of an online community support system devoted specifically to achieving these goals for a particular individual. Further, embodiments of the present invention embrace systems and methods for selectively distributing sensitive information in a timely and controlled manner to key people, organizations, and/or professionals, who are in positions to support a particular person, family, or group, and wherein the information is provided based on the positive impact/influence each can provide to the individual based on given circumstances in the individual's life.

2. Background and Related Art

In the health and human services and behavioral health industries, where individuals and families are being treated, there is often a need to communicate information, including sensitive information, between individuals, families, care providers, insurance providers, support groups, and the like. Nevertheless, in many cases there is a lack of transparency and coordination between departments and services in the government, insurance-funded programs, and programs within the private pay industry. This lack of coordination and transparency can result in people not getting the help they need. For instance, a person/family can miss out on available help because the person/family was not made aware of available services, or because the overall plan to support the person/family was not established or coordinated between providers of service. On the other hand, in some cases, the same lack of transparency or gaps in communication can allow for the defrauding of the government. For instance, the lack of communication between governmental programs may allow a person/family to take unfair advantage of governmental programs because each governmental department is not aware of the services/resources that have been given to a particular person/family.

While the Health Insurance Portability and Accountability Act and its associated laws (“HIPPA”) have been put in place to protect sensitive/confidential information, such laws can further contribute to the lack of transparency and lack of coordination between health service providers and others who could assist an individual or family in need. Additionally, information is often only shared within a particular organization or between professionals who continue on with similar types of care following another professional. In short, there is a great barrier to sharing relevant and timely information within professional networks, as well as the appropriate information with the informal systems of support that are available to families, friends, and others willing to support a person/family in need.

Thus, while techniques currently exist that are used to communicate information between individuals, families, care providers, support groups, and the like, challenges still exist, including that some current case management tools are not coordinated or transparent to the individual/family in need. Accordingly, it would be an improvement in the art to augment or even replace current techniques with other techniques.

### SUMMARY OF THE INVENTION

The present invention relates to collaboration and coordination of support. In particular, embodiments of the present invention relate to integrating and enabling assessment functionality, data reporting, communication tools, calendaring, and specific curriculum, along with the power of an online community support system devoted specifically to achieving these goals for a particular individual. Further, embodiments of the present invention embrace systems and methods for selectively distributing sensitive information in a timely and controlled manner to key people, organizations, and/or professionals, who are in positions to support a particular individual, family, or group, and wherein the information is provided based on the positive impact/influence each can provide to the individual based on given circumstances in the individual's life.

In at least some implementations of the present invention, each end user (parent, individual, and/or group) of the online support system is assigned a user role. Some examples of suitable roles include that of a guardian, a professional, a staff member, a team member, and the like. Additionally, each role has an accompanying access level, which indicates the type of interaction the user can have with the support system or team. In one example, a user's role indicates the type of information the user can access on the support system. For instance, while a user with one role (e.g., guardian or professional) can access an individual's medical records, a user with another role (e.g., team member) is not able to access the medical records.

While user roles may be assigned in any suitable manner, in some instances, the legal guardian of the individual assigns or approves each end user's role. Thus, in such instances, the guardian decides which type of information each user can access. In other implementations, the individual himself/herself assigns and approves each end users role for his/her online dynamic support group. Accordingly, implementation of the present invention empowers end users with the ability to provide and receive relevant role-based information and education to or from various support persons/entities in an automated manner.

The support system's human development purpose is to facilitate the transformation of an individual or group from current levels of functioning to higher levels based on their stated purpose and upon assessment of their current status. Implementations of the present invention place the individual, parent, or guardian (the client) in the center of access and control of information within a collaborative and controlled electronic support group.

Implementation of the present invention provides a mechanism for professionals to collaborate and coordinate their support efforts and for lay support persons to better know how to provide support within their specific roles. A coordinated support effort is facilitated through the sophistication of this technology, which identifies each person/entity on the support network by role/relationship and allows access to information based upon the role of that person.

Implementations of the present invention empower people who want to improve themselves and/or their family/group through an integration of “self-help” tools and processes that coordinate and facilitate the support of other significant individuals who, in some way, are interconnected with the person/family/group, especially in ways relevant to the desired changes.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating support system for use of the present invention;

FIG. 2 illustrates a representative embodiment of a networked system;

FIG. 3 illustrates a representative embodiment for a method of controlling access to information over an online support system;

FIGS. 4-5 each illustrate a representative embodiment of a homepage for an online support system;

FIG. 6 illustrates a representative embodiment of a library feature for an online support system;

FIG. 7 illustrates a representative embodiment of team member page for an online support system;

FIG. 8 illustrates a representative embodiment of a scrapbook feature for an online support system;

FIG. 9 illustrates a representative embodiment of a calendar feature for an online support system;

FIG. 10 illustrates a representative embodiment of an assessment tracking feature for an online support system;

FIG. 11 illustrates a representative embodiment of a links page for an online support system;

FIG. 12 illustrates a representative embodiment of a frequently-asked-questions page for an online support system;

FIG. 13 illustrates a representative embodiment of a give-back feature for an online support system;

FIG. 14 illustrates a flowchart for a representative embodiment of a method for tracking sensitive information accessed via an online support system; and

FIG. 15 illustrates a flowchart for a representative embodiment of providing support to a teen transitioning from a rehabilitation center.

### DETAILED DESCRIPTION OF THE INVENTION

The present invention relates to collaboration and coordination of support. In particular, embodiments of the present invention relate to integrating and enabling assessment functionality, data reporting, communication tools, calendaring, and specific curriculum, along with the power of an online community support system devoted specifically to achieving these goals for a particular individual. Further, embodiments of the present invention embrace systems and methods for selectively distributing sensitive information in a timely and controlled manner to key people, organizations, and/or professionals, who are in positions to support a particular person, family, or group, and wherein the information is provided based on the positive impact/influence each can provide to the individual based on given circumstances in the individual's life.

The following disclosure of the present invention is grouped into two subheadings, namely “Representative Operating Support System” and “Collaboration and Coordination of Support.” The utilization of the subheadings is for convenience of the reader only and is not to be construed as limiting in any sense.

### Representative Operating Support System

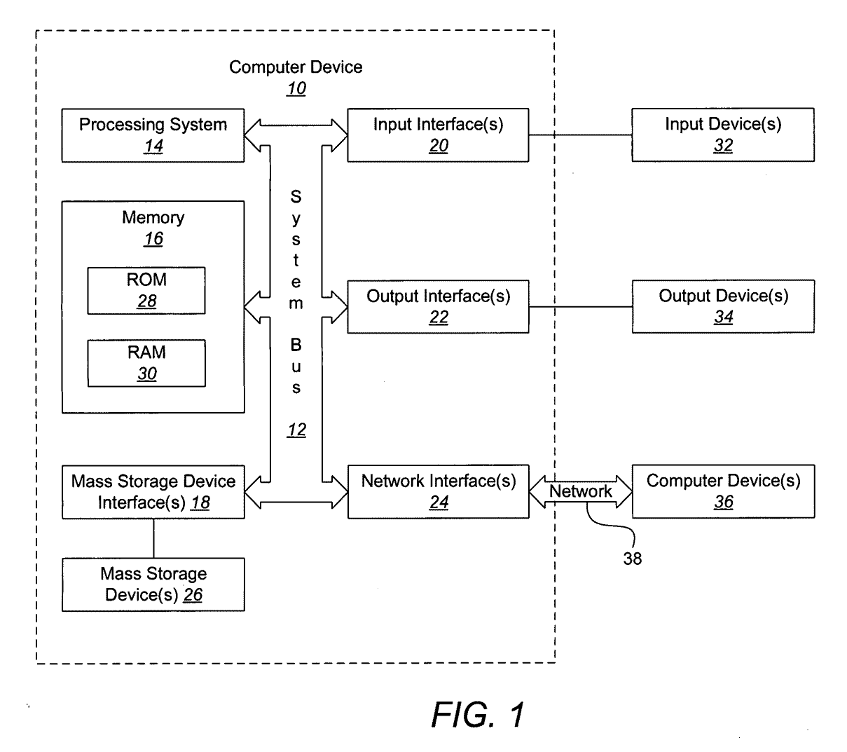

As provided herein, at least some embodiments of the present invention embrace online collaboration and coordination of support. Accordingly, FIG. 1 and the corresponding discussion are intended to provide a general description of a suitable computer device in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing support system, where functions or tasks are performed by a plurality of networked computer devices.

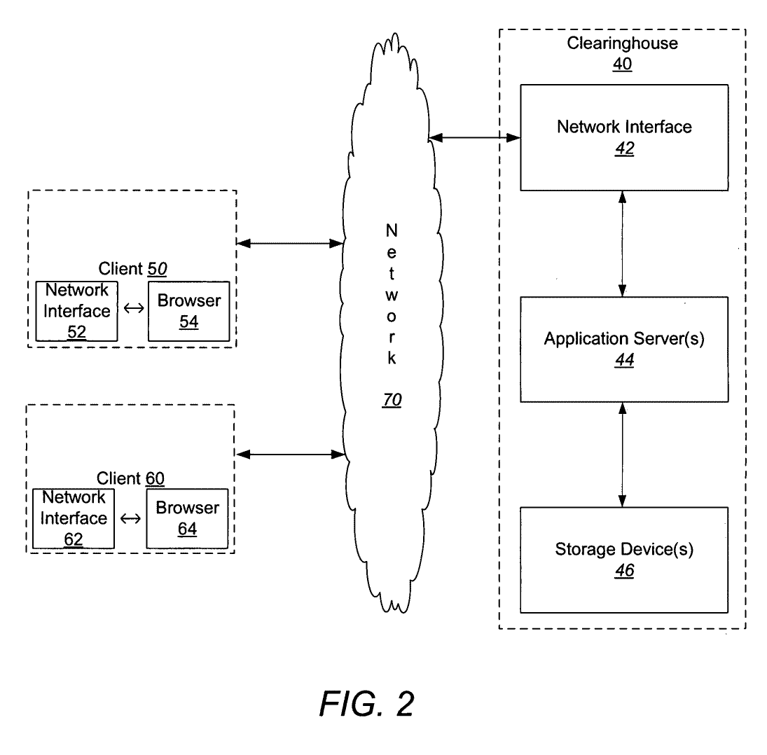

While those skilled in the art will appreciate that the invention may be practiced in networked computing support systems with many types of computer system configurations, FIG. 2 represents an embodiment of the present invention that enables clients to participate in collaboration of support across a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the internet.

In FIG. 2, clearinghouse 40 represents a system configuration that includes one or more servers that are used to receive and/or information relating to the collaboration and/or coordination of support. By way of example, clearinghouse 40 may be a single server in cases where a single server can process and preserve the entire amount of information required to perform the methods and systems of the present invention, as will be further explained below. Alternatively, clearinghouse 40 may be a conglomeration of servers that process and preserve a high volume of information.

With reference to FIG. 2, clients 50 and 60 each include a network interface (respectively illustrated as network interfaces 52 and 62) and a web browser (respectively illustrated as browsers 54 and 64). Network interface 52 is a communication mechanism that allows a client, such as client 50 to communicate to clearinghouse 40 by a network 70, such as the internet. Browser 54 is an application program that allows information to be displayed on a monitor device as text and/or graphics in the form of a web page. A browser allows for the entering of uniform resource locator (“URL”) to thereby access the corresponding web page. Therefore, clients 50 and 60 may independently access a web page that enables collaborative communication and exchange within a controlled electronic environment that acts as a support group for an individual, such as a troubled teen or other individual.

Clearinghouse 40 includes network interface 42, application servers 44, and storage device 46. Network interface 42 is a communication mechanism that allows clearinghouse 40 to communicate with one or more clients by a network 70. Application servers 44 include one or more servers for processing and/or preserving information, and may be employed for providing and maintaining a web page that enables controlled electronic collaboration and exchange within the focused online support group. Storage device 46 includes one or more storage devices for preserving information.

Thus, a user at one of the clients, such as client 50, may access a web page maintained by one or more of the application servers 44 and electronically collaborate relating to support, as will be further explained below.

While the discussion above has presented a representative system configuration for implementing the present invention, those skilled in the art will appreciate that the methods of the present invention and processes thereof may be implemented in a variety of different system configurations.

### Collaboration and Coordination of Support

As provided herein, embodiments of the present invention relate to systems and methods for collaborating and coordinating support for an individual that is trying to maintain or improve a current level of function to a higher level of function. In particular, embodiments of the present invention relate to integrating and enabling assessment functionality, data reporting, communication tools, calendaring, specific curriculum, and/or other features with the power of an online community support system devoted to achieving specific goals to help the individual. Further, embodiments of the present invention embrace systems and methods for selectively distributing sensitive information in an instantaneous and controlled manner to key people, organizations, and professionals, who are in positions to support a particular individual, family, and/or group.

Generally, the described systems and methods provide a dynamic, online, and collaborative support system that may be accessed by a plurality of users. Through the online support system, users are able to collaborate their efforts with the efforts of other users to help an individual improve from a current level of function to a higher level of function. The online support system also facilitates communication between its users and the coordination of its users' efforts by identifying each user by role, or relationship to the individual, and then providing access to information based upon the user's specific role.

The described systems and methods may be used to benefit and provide support to any individual or individuals (“individual”) who are in the process of maintaining a current level of function, or improving from the current level to a higher level of function. Some examples of such an individual include a person who is incarcerated (e.g., in a jail, a detention center, etc.), on parole, in a rehabilitation center (e.g., a drug-rehabilitation center, a mental rehabilitation center, etc.), in marital counseling, in psychological counseling, on probation (e.g., academic probation, etc.), in a care facility (e.g., a rest home, an asylum, etc.), transitioning out of a program (e.g., an addiction recovery program, etc.), in coaching, or who otherwise recognizes or is recognized by others as being likely to benefit from an online support system. Additionally, the individual may have virtually any characteristic, such as age, ethnicity, socio-economic status, and so forth. In one example, the individual is a teen transitioning home from a drug-treatment program.

As mentioned, the described systems and methods comprise an online dynamic support system that is accessible by the individual and a plurality of users predetermined to be members of a focused support group. While the described systems and methods may be used by virtually any person, in some embodiments, each person who uses the online support system (or “user”) is a person who cares for, can help, has influenced or who can be influential in the life of an individual, as defined herein. For example, besides the individual, the users may comprise one or more parents, family members, friends, ecclesiastical leaders, specialists, counselors, coaches, peers and/or any other person who can help and/or influence the individual. All of the users that have access to an account on the online support system that is dedicated to providing support to a specific individual may collectively be referred to as home team members.

As previously stated, each team member may be assigned a role. While a team member may be given any suitable role, some examples of suitable team member or user roles comprise the role of legal guardian, staff member, administrator, and/or “other team member” (or any team member that does not qualify as a legal guardian, a staff member, or an administrator). Additionally, each role may be subdivided in any suitable manner. In one example, the other team member role is subdivided into other team members that are adults; family members; friends; professionals who are not staff of an organization, program, or consulting agency that uses the online support system; and so forth. In a second example, the administrator role is subdivided into program administrators and super administrators.

As used herein, the term legal guardian, or variations thereof, may refer to one or more adult team members of the online support system who are legally responsible for the care of the individual (e.g., capable of consenting to the sharing of information about the individual with others, wherein the information is protected by HIPPA). Some examples of suitable legal guardians can include at least one parent, guardian, spouse, or any other suitable adult having a power of attorney for the individual. Similarly, as used herein, the term staff member, or variations thereof, may refer to any person who works under the direction of an organization, program, agency, or the like to help the individual. Some examples of staff members may include therapists, consultants, counselors, coaches, staff members, medical professionals, or other people who are employed by, volunteer for, or otherwise work on behalf of an organization, program, or the like that is attempting to help the individual. Additionally, as used herein, the term administrator, or variations thereof, may refer to one or more people with administrative access to the online support system. Some examples of an administrator include a program head, an information technology specialist, etc.

A team member's role can be assigned in any suitable manner. For instance, a team Member's role can be assigned to a user based on that particular user's relationship with the individual. In some embodiments, however, each user's role and participation as a team member is assigned and/or approved by the individual's legal guardian(s), or by the individual itself, if the individual is a legally recognized adult (e.g., able to enter into legally binding contracts). In one example, an individual's legal guardian may choose to assign one professional the role of professional while assigning another professional the role of other team member. In another example, the individual's legal guardian may allow one of the individual's family members to have the role of other team member while preventing another family member from becoming a team member altogether.

To some extent, each of the home team member's access to information on and/or ability to interact with the online support system is determined by the team member's role and the role's accompanying access level. Further, the types of information that can be accessed and the user's ability to interact with the system may be set for any role in any suitable manner. By way of example, a team member with the role of legal guardian, staff member, or administrator may be allowed to view sensitive information (e.g., medical records), which a person with the role of other team member is not allowed to view. In another example, while a user with the role of administrator or professional may be allowed to view sensitive information for a plurality of individuals, a person with the role of legal guardian may only view sensitive information for the individual for which the guardian has legal responsibility.

Because access to some sensitive information is restricted according to the user's roles, sensitive information is easily shared with one or more team members having an appropriate access level, without sharing such information with team members having an inappropriate access level. Thus, information, such as medical records that are protected by HIPPA or similar practices, may be easily shared with a select group of home team members to allow team members to communicate and coordinate their efforts to help the individual.

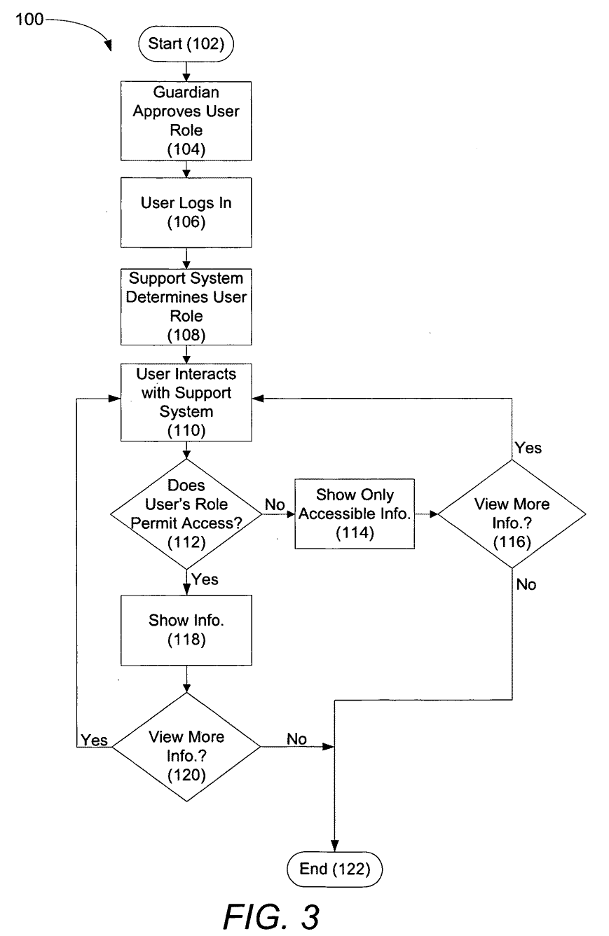

While the online support system may use a team member's role in any suitable manner to determine how the team member is able to interact with the online support system, one example of a suitable method for controlling access to information is shown in FIG. 3. Specifically, FIG. 3 shows that after starting at box 102, the method 100 continues to box 104, where the individual's legal guardian (or the individual, if a legal adult) approves a person to become a team member and further approves the team member's specific role, with its accompanying access level. In some embodiments, by approving the team member's role, the guardian legally consents to allowing that team member to have access to a certain level of information. In one example, by assigning or approving a person to the role of staff member, the guardian legally consents to allowing that person to view the individual's medical records.

At box 106, FIG. 3 shows the method continues as the user/team member logs onto the online support system. As the team member logs in, box 108 shows the support system determines the user's role (e.g., legal guardian, staff member, other team member, administrator, etc.). Next, box 110 shows the team member is allowed to interact with the support system.

As the team member interacts with the system, box 112 shows that the system determines whether the team member's role allows that team member to have access to certain sensitive information, to edit certain information, or to otherwise interact with the system in a certain way. If the member's role does not permit a certain interaction, such as access to certain sensitive information, box 114 shows the team member is only granted access to information not restricted to users with that team member's role. After viewing such information, box 116 shows the team member is allowed to view more information or otherwise interact with the system by returning to box 110. In the alternative, FIG. 3 shows that if the member chooses not to view additional information, the member's session ends at 122.

Returning to box 112, if the system determines the member's role permits access to certain sensitive information (or another interaction); box 118 shows that the system allows the member to access such information. Following this interaction, the member decides whether to continue interacting with the system (e.g., viewing additional content), as shown at 120. If the member chooses to continue interacting with the system, FIG. 3 shows the method returns to box 110. In the alternative, FIG. 3 shows that if the member chooses to stop interacting with the system, the method ends at 122.

In order to better explain the online support system and its methods of use, some embodiments of the online support system are discussed below. Generally, the online support system can have virtually any feature that allows it to provide a conduit through which a plurality of users may collaborate and coordinate their support efforts for an individual. Some examples of suitable features comprise a homepage, a library feature, a message center, a team member center, a scrapbook feature, a photo gallery, a calendar feature, an assessment tool, a notification feature, a user-customizable links page, a blog feature, a dynamic frequently-asked-questions page, a give-back feature, a research feature, and/or a banish feature. To provide a better understanding of the online support system, the following description provides a more detailed description of each of the aforementioned features.

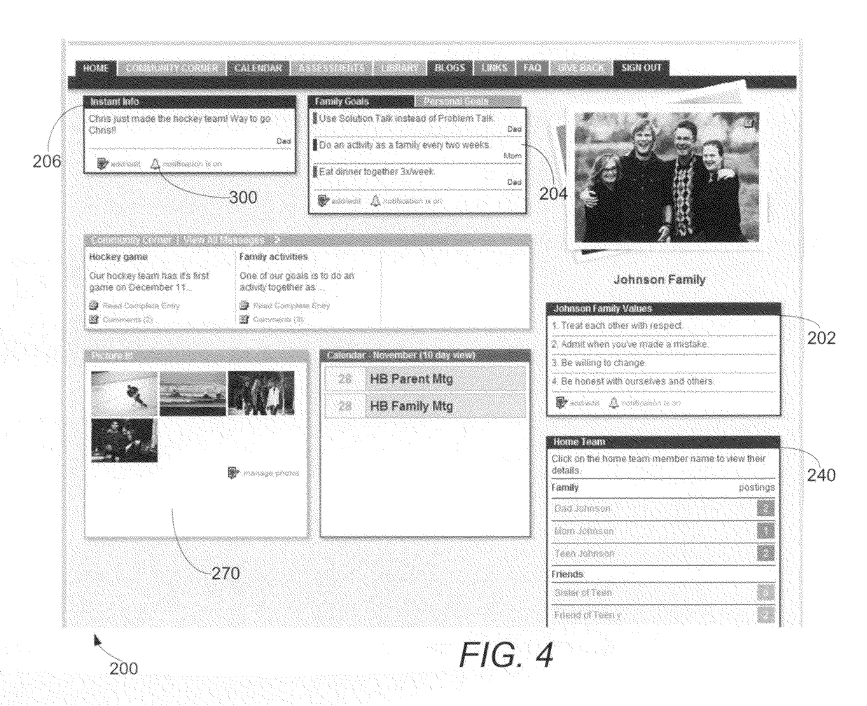

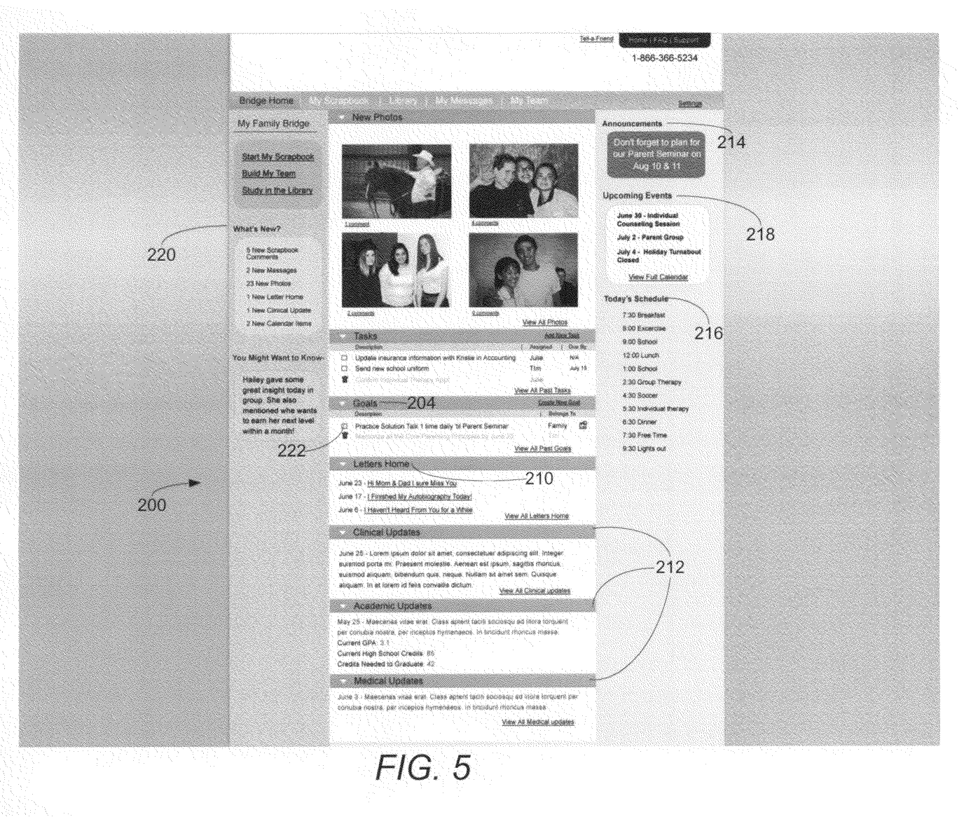

In some embodiments, the online support system comprises a homepage. Such a homepage may comprise any suitable component or content. By way of illustration, FIGS. 4 and 5 shows some embodiments of suitable homepages. Specifically, FIG. 4 shows the webpage 200 can comprise several features or links to several features, such as a values feature 202, a goals feature 204, and/or an instant information feature 206. Additionally, FIG. 5 shows the homepage 200 can further comprise a tasks feature 208; a letters feature 210; an update feature 212; an announcements feature 214; a daily schedule feature 216, an upcoming events feature 218, and/or a what's new feature 220. While each of these aforementioned features, or links to each of these features, can be disposed on the homepage, they can also be disposed in any other suitable location or page within the support system. To provide a better understanding of these features, the features are discussed below, with respect to the homepage, in more detail.

FIG. 5 shows one example in which the homepage 200 comprises a values feature 202. While the values feature may serve any suitable purpose, in some cases, the feature acts to remind team members to support the individual and/or the individual's family in a manner that is in harmony with the stated values comprises a list of values. Accordingly, the values feature may comprise a list of any appropriate value(s), including one or more family values, personal values, program values, etc.

FIG. 4 shows an example in which the homepage further comprises a goals feature 204. The goals feature may serve any suitable purpose. For instance, it has been found that posting goals in a public setting may help the family and/or the individual obtain specific support from other team members. Similarly, it has been found that sharing goals with the home team increases the team members' odds of accomplishing those goals.

The goals feature may allow virtually any goal to be posted by virtually any individual. For instance, the goals feature may allow the individual, guardian, other home team member, professional, and any other user to post goals. In one example, the goals feature allows goals an entire family to post both family and personal goals. In another example, the goals feature allows team members to set team and personal goals. For instance, a team member may post the goal of taking the individual to lunch each month.

The goals feature may function in any suitable manner. In one example, FIG. 4 shows the goals feature 204 lists the name and/or role of the team member who posted or who is responsible for the goal (e.g., Dad and Mom). In another example, the goals function lists the goals due date. In still another example, FIG. 5 shows the goals feature 204 comprises a checkbox 222 that allows a user to mark the goal as being completed. In this example, the completed goal can be marked in any suitable manner. For instance, the text color of the goal turns grey, the goal drops to a recycle/trash icon, etc. In yet another example, the goals feature allows a user to select a goal icon and create, edit, and/or delete a goal in a single step. In a final example, the goals feature sorts and displays the goals according to who made/owns the goal. For instance, the goals may be separated into family goals, guardian goals (e.g., mom and/or dad's goals), the individual's goals, home team goals, etc.

FIG. 4 further shows an example in which the homepage 200 comprises an instant information feature 206. Generally, this feature allows one or more team members to send out an important message (whether it be positive or negative) to family and other Home Team members. Accordingly, the instant information feature can help keep team members apprised of recent events and can quickly rally necessary support in response to the message. The instant information feature may comprise any suitable characteristic. Additionally, this feature may function in any suitable manner. For example, the instant information feature may post information on a page (e.g., the homepage) as soon as the information is posed. In another example, the instant information features posts the information on a page and/or sends a message (e.g., an email, a text message, instant message, RSS feed, etc.) to one or more selected team members.

FIG. 5 shows an example in which the homepage 200 further comprises a tasks feature 208. While the tasks feature may serve any suitable purpose, in some cases, this feature reminds one or more team members of one or more matters that need to be completed. The tasks feature may comprise any characteristic that allows it to fulfill its intended purpose. Indeed, in some instances, the tasks feature is configured to allow a user to indicate a task's requirements, who set up the task, the person responsible for completing the task, the due date of the task (see 216 in FIG. 5). In some instances, the tasks feature allows a user to set an automatic reminder (e.g., an automatic e-mail, page, instant message, or the like) that is triggered when a task's due date approaches. Additionally, in some instances, a user (e.g., an administrator or staff member) can add automated tasks to the tasks feature to cause tasks to automatically appear on the tasks' start date and/or due date. In such instances, the tasks feature can further remind the user in any suitable way (e.g., by turning the task's text red on their due date, by sending a reminder e-mail, etc.).

FIG. 5 further shows an example in which the homepage 200 comprises a letters feature 210. In some cases, this feature alerts one or more team members (e.g., a guardian) that a letter has been sent electronically to that member(s). In some instances, the letters feature further provides the appropriate user with access to an electronic version of the letter. For instance, where a letter is written by hand, the online support system can post a scanned image of the letter. Accordingly, such a feature may allow a person, such as an individual, who is not able to type a letter on a computer to still send letters electronically to indented recipients. While the letters feature may have any suitable characteristic, in some instances, the letters feature alerts the user of any letters sent to the user and uploads the letter into a letters section, placing the most recent letter first.

FIG. 5 also shows an example in which the homepage 200 comprises an update feature 212 that displays academic, clinical, medical, and/or other information regarding the individual. Accordingly, members with role having an access level that allows the member to see such information may be kept abreast of such information. Accordingly, such members can better direct their efforts to support the individual in the areas discussed in the update feature.

This update feature may display any suitable information individual's status (e.g., academic, clinical, and/or medical status). For instance, the update feature may display any suitable information regarding the individual's academic activities, including, but not limited to, the individual's behavioral performance grades, grade point average, class grades, credits earned, credits needed, topics covered in class, etc. Similarly, in some instances, this update feature comprises any suitable information relating the individual's clinical or medical activities, including but not limited to, the individual's attendance of counseling sessions, medication use, health status, etc.

FIG. 5 also shows an example in which the homepage 200 comprises an announcements feature 214. While this feature may perform any suitable function, in some instances, this function acts informs/reminds team members of announcements. While such a feature may have any characteristic, in some instances, the announcements feature is customizable to allow a user (e.g., a parent, home team professional, the individual, etc.) to determine how long a particular announcement will be posted. Additionally, in some instances, the announcements feature automatically displays announcements at a designated time.

FIG. 5 shows that, in some embodiments, the homepage 200 comprises a daily schedule 216. The feature may serve any function, including alerting home team members to the individual's schedule. The daily schedule can have any suitable characteristic. In one example, the daily schedule is populated with information in any suitable manner. For instance, the daily schedule can pull its information for a schedule database that is provided by a program, organization, or the like. In another example, the daily schedule allows a user (e.g., a parent or an individual) to view schedules from several days. For example, a parent accessing the online support system could view its teen's schedule to determine an appropriate time to call the teen.

FIG. 5 also shows an example in which the homepage comprises an upcoming events feature 218. While this feature may serve any suitable purpose, in some instances, this feature provides the user with an overview of events planned to occur in a specified period of time (e.g., the next week, this month, etc.). While the upcoming events feature may comprise any suitable characteristic, in some instances, this feature comprises one or more links to a calendar feature (discussed below) to allow a particular user to view access a full calendar view.

FIG. 5 further shows an example in which the homepage 200 comprises a what's new feature 220. The what's new feature may perform any suitable function, including alerting a user of changes that have occurred on the support system since the user's last login. The what's new feature may alert the user of any desired changes, such as news postings, photos, task updates, goal changes, calendar changes, clinical updates, academic updates, medical updates, scrapbook topics, scrapbook comments, library changes, messages posted, team member updates, and the like. In some embodiments, the what's new feature further indicates the number of changes in a particular category. The what's new feature can comprise any suitable characteristic. In one example, the feature states the number of changes that have occurred in a given category. For instance, FIG. 5 shows the what's new feature 220 states “27 New Photographs.” This posting indicates that 23 photos were posted since this particular user's last login. Additionally, in another example, the what's new feature comprises hyperlinks that directs the user to the updated information when the user selects the link.

As previously mentioned, in some embodiments, the online support system also comprises a library feature. The library feature may serve any purpose. In one example, the library comprises specific information that can allow users to educate themselves on how to help the individual. For instance where the individual is a recovering drug addict, the library may contain specific information on how to help a recovering drug addict transition home, stay clean, etc. Accordingly, the library feature may help parents and other users learn and implement principles that are important to the individual's particular situation and success. Additionally, the library feature may comprise any form of content, including, but not limited to articles, books, video feeds, audio feeds, interactive tools, webinars (i.e., live and recorded), podcasts, MP3s, featured content provided by specialists, etc.

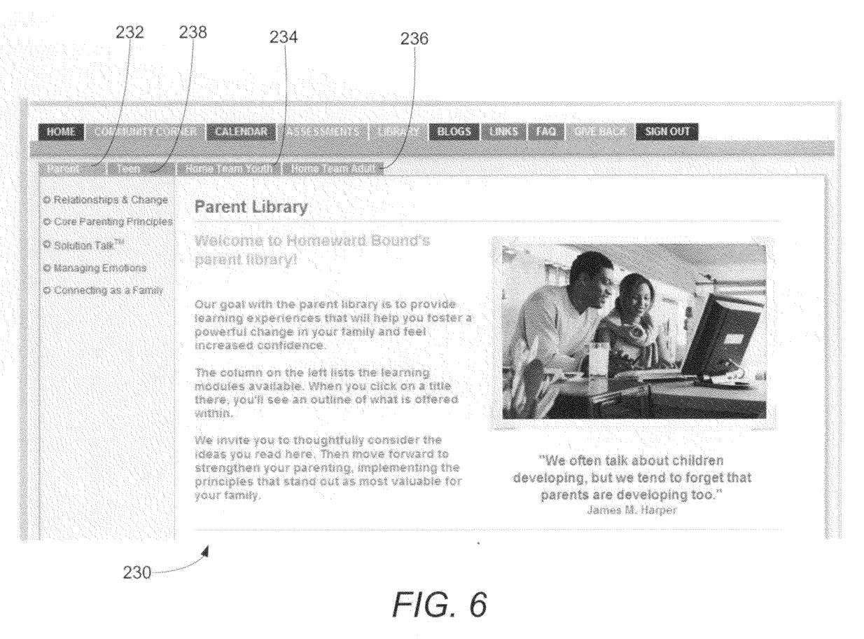

In some embodiments, the library feature is organized for specific user roles. Accordingly, the library may provide specific information for each user that educates the user on how to better fill the user's role in aiding the individual. While the library may be organized in any suitable manner and for any suitable role, FIG. 6 shows one example in which the library 230 is organized to contain a parent library 232, a home team library for youth 234, a home team library for adults 236, and/or a library specific to the particular user (i.e., the individual (as shown by 238), a guardian, etc). For simplicity, this library that is specific to a particular user may be referred to as my library.

In some instances, access to one or more of the various library categories is limited according to a user's role. In one example, a user having a role of a youth team member may access the home team library for youth but not the home team library for adults. In another example, the user may select which other users may have access to the user's my library feature. For instance, a guardian may select certain information that the guardian wants staff members to see, but not youth team members.

Additionally, the information in the library feature may be provided by any suitable source. In one example, a program or organization provides content that is specific to team members helping an individual with specific problems. In this example, the program/organization can further organize the content related to the individual's specific problem into categories directed to guardians, youth team members, adult team members, etc. Additionally, in this example, the program/organization can also determine the order in which the users are able to access the content within the library. In another example, content for the my library feature is provided by a specific user (e. g., a parent or home team professional) to upload specific content that the user wants other users (e.g., parents and/or professionals to see).

In some embodiments, the online support system further comprises one or more message centers. While the message center may serve any suitable purpose, in some instances, the message center allows a user to post information to be seen (e.g., on a message board, an e-mail, an instant message, etc.) by one or more other team members. For instance, the message center may allow the individual or another user to post a message or comment that can only be viewed by one or more selected team members. In one example, individual may wish to post a message that can only be seen by the specific staff member.

In some cases, however, the message center comprises a role-restricted communications conduit. In other words, in some instances, the user who posts a message may select which team member(s) can see a message, based on team members' role(s). In one example, the message center is organized and subdivided so that only users with a certain role can access certain messages.

While the message center may be organized in any suitable manner, in some instances, the message center is organized in sections, such as a general section, a guardian-to-guardian section, a professional section, an ask-a-specialist section, and so forth. In such instances, all users can view and/or edit messages in the general section. In contrast, access to the guardian-to-guardian section is restricted to guardians. As a result, one guardian can post messages to other guardians while preventing others, such as the individual, from seeing the content of the message. Similarly, the professional section can allow professionals communicate with each other over the online support system without allowing others to see their communications. Moreover, the ask-a-specialist section can allow guardians to privately communicate with a specialist over the online support system. By providing a private forum for professionals and/or professionals and guardians, the described support system allows professionals to communicate sensitive information in a manner that complies with many privacy laws, such as HIPPA.

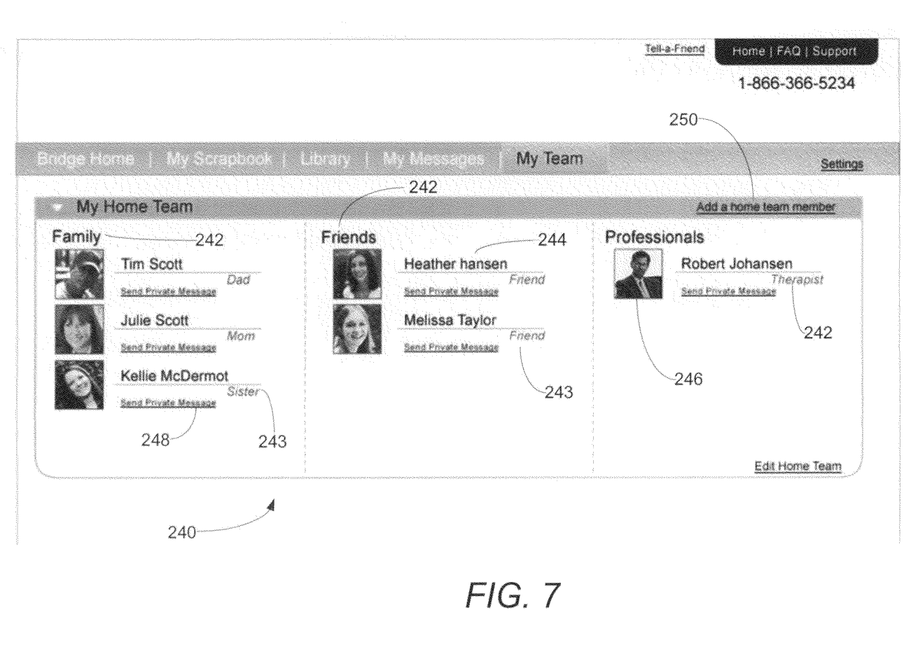

FIG. 7 (and FIG. 4) shows that, in some embodiments, the online support system comprises team member center 240. Generally, the team member center may comprise any information relating to a team member. By way of illustration, FIG. 7 illustrates a representative embodiment of a team member center 240 that lists the role 242, title 243, and name 244 of a plurality of users who are home team members. Additionally, FIG. 7 shows an example in which the team member center 240 comprises a photograph 246 of one or more users. In this example, the photograph optionally has a rollover feature for enlarging the image or a hyperlink linking the image to another page comprising more information about the user.

In addition to the aforementioned characteristics, the team member center may comprise any other suitable characteristic. In one example, FIG. 7 shows that the team member center 240 organizes and displays user information according to user's role (e.g., family member, friends, professionals, etc.) In another example, FIG. 7 shows the team member center 240 comprises a link 248 to send a private message to an individual team member. In this example, if a user selects the link, the message center is opened and a blank message is addressed to the selected user. In still another example, FIG. 7 shows the team member center comprises an edit feature that allows a user to edit their profile.

In yet another example, FIG. 7 shows the team member center 240 comprises a feature 250 for adding or inviting a new home team member. In this example, this feature may request any suitable information, such as a name, e-mail address, role (e.g., guardian, other team member, professional, etc.), title (e.g., neighbor, aunt, family, therapist), and/or group (parent family, friend, professional etc.). After receiving the information, the online support system sends an e-mail to the invitee. This e-mail can explain that the invitee has been asked to join the online support system and provide the invitee with the information necessary for joining the online support system (e.g., a URL link, a password, a user name, etc.). However, before the invitee is allowed to access the support system, the guardian (or individual, if a legal adult) is allowed to approve or deny the invitee for a particular role.

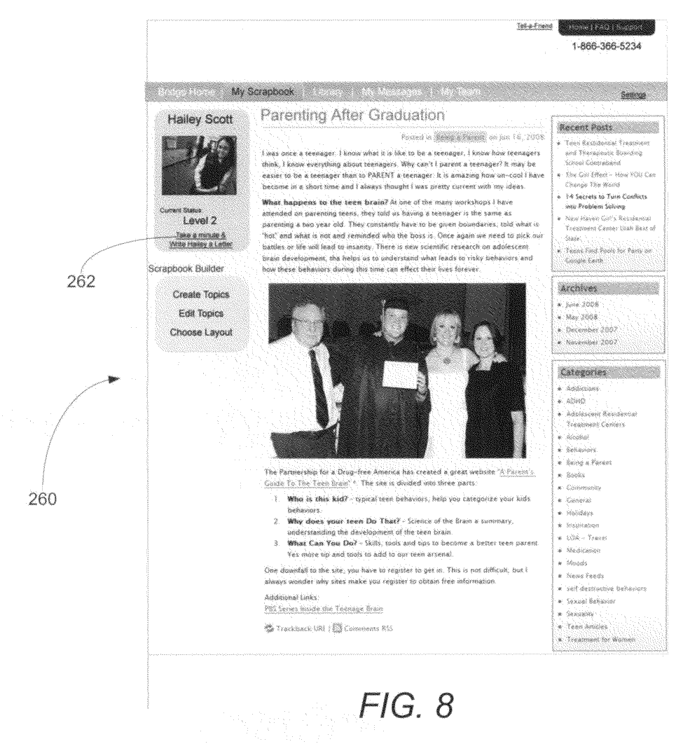

FIG. 8 shows, that in at least some embodiments, the online support system comprises a scrapbook feature 260. Generally, the scrapbook feature allows one or more users to build a scrapbook that is accessible via the support system. The scrapbook feature may allow a user to post any suitable content. For example, a user may build a scrapbook page about themselves, an activity, a topic of interest, etc. For instance, the scrapbook feature optionally comprises a picture of the user (e.g., the individual). Additionally, FIG. 8 shows that, in some instances, the scrapbook feature 260 comprises a link 262 that allows a user to send a message to the creator of the scrapbook page (e.g., the individual). In such instances, the message may be delivered to the individual in any suitable manner. For example, the message may be reduced to a PDF for printing or may be e-mailed to the individual.

Additionally, a user may add content to the scrapbook feature in any suitable manner. For instance, the scrapbook feature may comprise a template feature or a blogging system (e.g., WORDPRESS®) that allows the user to select a layout, add a topic, add content (e.g., text, pictures, etc.), or otherwise edit the scrapbook.

In some embodiments, the online support system comprises a photo gallery. The photo gallery can serve any purpose, including allowing users to see the progress of the individual over time. The photo gallery can have any suitable characteristic. In one example, FIG. 4 shows the homepage 200 (or any other suitable page of the online support system) displays thumbnails of recent or favorite photographs 270. In this example, the thumbnails optionally have a hyperlink to a larger image or have a roll-over feature that enlarges the photo when selected.

In another example, the photo gallery comprises any suitable content. For instance, the photo gallery can contain images, photographs, videos, and/or other content posted by any suitable user (e.g., the individual, parents, etc.). In still another example, the photo gallery is subdivided in smaller galleries. In this example, each sub-gallery may comprise information relating to the number of pictures in the gallery, the theme of the gallery (e.g., the date the photos were taken, the event shown in the photos, etc.), when the gallery was last updated, etc. In yet another example, the photo gallery comprises a link that allows a user to view, add, or edit comments related to the content. In a final example, the photo gallery optionally has a feature that allows a user to select photographs to be printed and to be sent to the user. For instance, where the individual is incarcerated, the individual may select several pictures, which will be printed at a remote location and then be sent to the individual through a mail service.

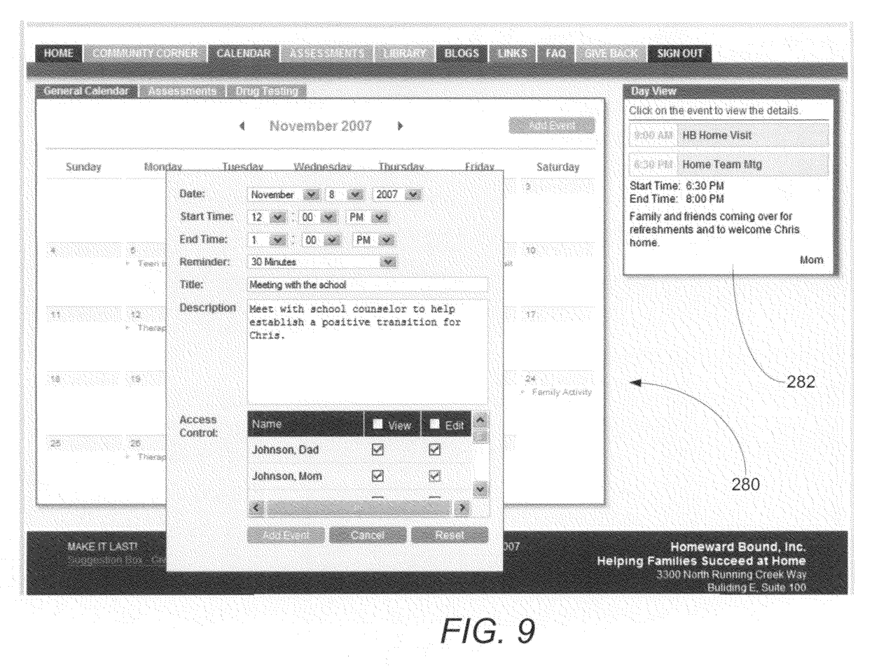

FIG. 9 shows that, in some embodiments, the online support system comprises a calendar feature 280. The Calendar feature can serve several purposes, including allowing users to organize information respective to their personal activities, family activities, goals, etc. By way of example, a user can populate calendar events for a family as a way of giving structure to the family's use of the library or as a way for scheduling the administration of drug tests to the individual.

When a calendar item is posted, a user may input any suitable information. For example, FIG. 9 shows a user can input information, such as the date of the event, the starting time and ending time of the event, when a reminder will be sent, a title, a description of the event, and who will be able to view or edit the event (“access control”). Thus, the calendar feature allows a user to provide information that is specific for a particular event. Moreover, the calendar feature also allows the users having a role with the correct access level to edit the calendar event in any suitable manner (e.g., allowing the users to move an event forward or backward to adjust for personal circumstances). Where the user chooses to have a reminder given, a reminder (e.g., an e-mail reminder) is automatically sent to those users who were given viewable access to the event.

FIG. 9 shows that, in at least one embodiment, details of an event can be viewed in box 282 to a side of the calendar 280. In this embodiment, FIG. 9 shows the box 282 can display all events for a particular day and that the details of the event are expanded when the event is selected. Furthermore, FIG. 9 shows that the details of the event can include the name and/or role of the scheduler of the event (e.g., Mom).

In some embodiments, the online support system comprises an assessment tool, which allows the status (e.g., progress) of the individual to be tracked, recorded, and/or reported. In other words, the assessment feature records and provides valuable information to the family and others about the individual's and/or other user's progress towards their goals. Accordingly, the assessment feature may gather or receive any information that tends to show the status of the individual and/or another user. For instance, the assessment feature may be used to track and record goal completion, drug test results, and/or any other suitable information relating to a user's status.

The assessment feature may gather or receive status information in any suitable manner. In one example, the assessment feature gathers and/or receives information through the use of an online questionnaire, the filling out of an electronically-readable assessment questionnaire, the input of a user (e.g., a therapist entering information from a recent assessment, etc.), and/or any other suitable manner.

In some instances, the assessment feature is automated in several ways. In one example, when an assessment (e.g., an electronically-readable assessment questionnaire, etc.) is scheduled on the calendar, an automatic e-mail reminder is sent out to invite the user to take the assessment. For instance, the guardians and the individual (e.g., a teenager) may receive an e-mail monthly and weekly, asking them to take an assessment.

While assessments may be used for any purpose, in some instances, weekly assessments can be designed to provide general progress updates on the family and individual as well as to provide specific feedback to the primary professional. Additionally, in some instances, monthly assessments may be more specific and provide valuable information that can help direct the family members and other users to relevant curriculum or other guidance based on areas that need improvement.

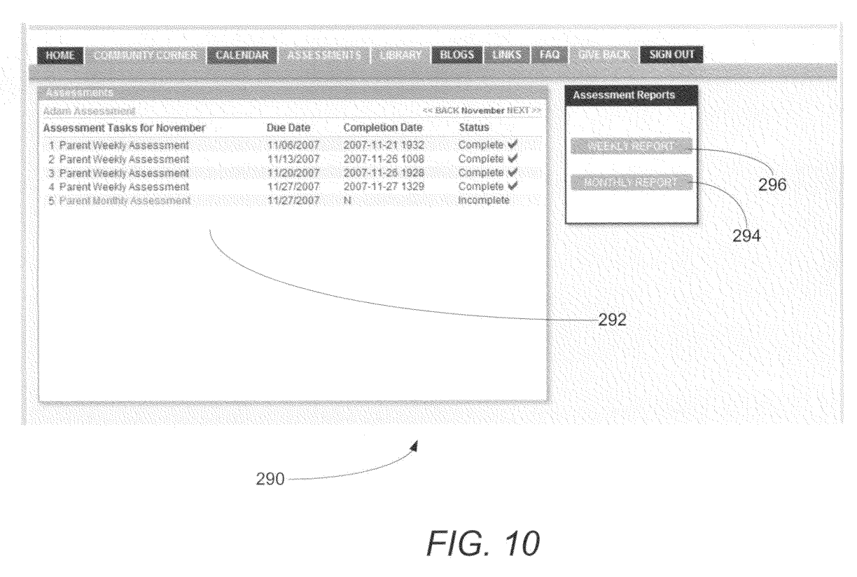

The assessment information may be tracked in any suitable manner. By way of illustration, FIG. 10 shows a representative embodiment of an assessment tracking feature 290. Specifically, FIG. 10 shows that once an assessment has been scheduled, information regarding the assessment (e.g., due date, completion date, status, etc.) is placed in a table 292.

In some embodiments, electronic assessment results are routed to a database. From the database, reports can be generated in any suitable manner. By way of example, FIG. 10 shows an embodiment in which the assessment window 290 comprises a button (e.g., monthly report 294 or weekly report 296) for requesting a report. In some instances, navigation options are available within the report itself. For example, a user with a sufficient access level (e.g., a guardian or staff member) can view detailed information from previous weekly reports simply by selecting the desired week. Additionally, in some instances, copies of the reports are created in a PDF, or other suitable format, and are shared with others, as desired (e.g., by the parents).

In some embodiments, the assessment information stored in the database is a used for research. For example, an organization, such as the program, can access the assessment data from numerous families for a variety of research purposes. This benefit allows the program, or another organization, to collect research data while providing a direct benefit (progress reports and guided curriculum) to the families, groups, and/or individuals that provided the data.

The feedback may obtained from the assessments may be used in any suitable manner. In one example, the feedback is used to redirect the efforts of team members to ensure their efforts are directed to the areas that the assessments show need additional attention. In another example, support system and/or a user (e.g., a staff member) uses the information from the assessment to update the library to contain information that will help team members and the individual progress in trouble areas that were identified in the assessments.

In some embodiments, the online support system comprises a notification feature. In such embodiments, one or more users have the ability to turn on and off the notification preference for various features on the site. When the notification preference is on, the user is sent an email or otherwise notified when new information is posted in a feature within the online support system. For instance, a user may receive an e-mail, see a popup, hear a sound, or otherwise receive a notification indicating that new content has been added to the goals feature, the photo gallery, the message center, etc. Additionally, a user can select which features of the online support system will implement the notification preference. In one example, the user turns the notification on for guardian-to-guardian messages but chooses to turn it off for the photo gallery. Along these lines, the notification preference may be turned on or off in any suitable manner. For instance, FIG. 4 illustrates a representative embodiment in which the notification preference is turned on and off by a bell icon 300 that acts as a toggle switch.

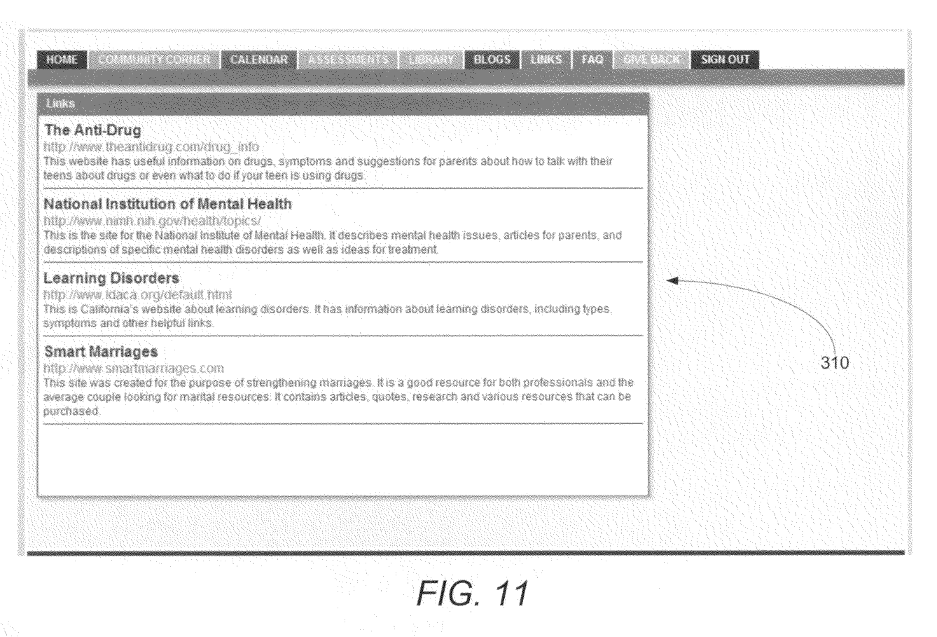

In some embodiments, the online support system comprises a links feature. Generally, the links feature comprises one or more lists of relevant links along with a brief description of a link. By way of illustration, FIG. 11 shows a representative embodiment of a links page 310 with several links that are specific for a family with a teen returning from a treatment program. While the links page may offer several benefits, in some cases, it helps direct users to pertinent information in an efficient manner.

To further increase the relevance of the links, in some instances, the links feature is user-customizable, or capable of being personalized for one or more users/roles. The links feature can be customized in any suitable way. In one example, a program specifies certain links that are only visible to certain user roles. In another example, a user adds personal links that will be visible the user alone.

In some embodiments, the online support system further comprises a blog feature. This blog feature may serve several purposes, including allowing a user (e.g., the individual) to keep an online journal or to view blogs from other users. Additionally, the blog feature may allow users to share thoughts and feelings online that they would not otherwise.

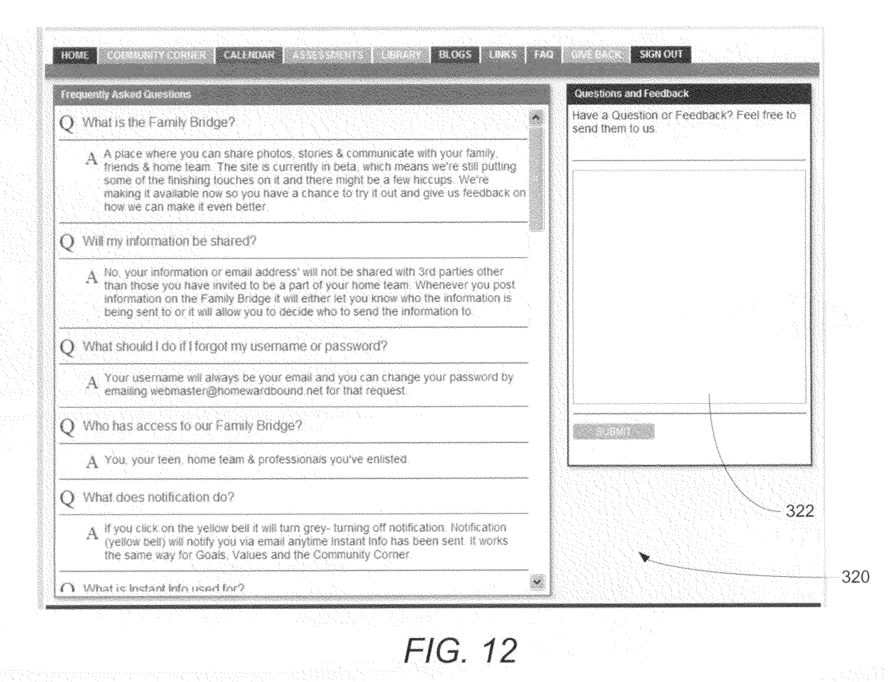

In some embodiments, the online support system comprises a dynamic frequently-asked-questions feature (“FAQ”). While in some instances the FAQ feature comprises a list of frequently asked questions and corresponding answers, in other embodiments, FIG. 12 shows the FAQ feature 304 allows users to submit questions and suggestions in any suitable manner (e.g., via in instant messaging feature 322).

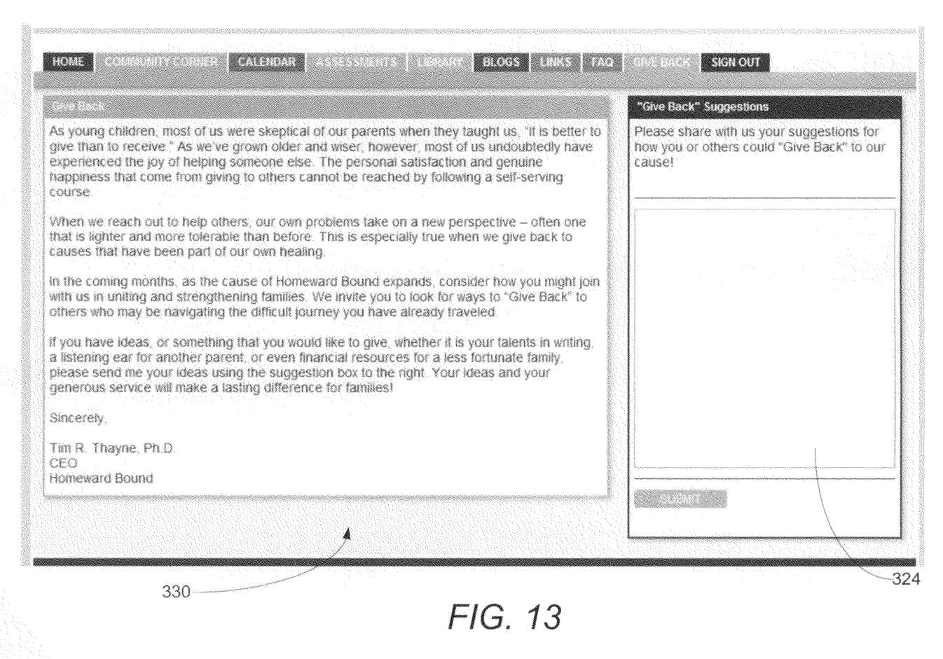

In some embodiments, the online support system comprises a “give-back” feature. Generally, this feature invites users to submit ways to reach out to other families and individuals in need. The give-back feature may function in any suitable manner. In one example, the give-back feature allows users to post ideas and suggestions of how to give back (e.g., via an instant message feature 324). In another example, FIG. 13 shows the give-back feature 330 provides the user(s) with information to inspire the user to help the user help another.

In still other embodiments, the online support system comprises a banish feature. In such embodiments, the banish feature allows a guardian, the individual (if a legal adult), or another user (e.g., an administrator) to lock a specific user (e.g., a user that is detrimental to the cause and/or mission of the online support system) out of the online support system. In some instances, the banish feature also allows a guardian, the individual (if a legal adult), or another user (e.g., an administrator) to reduce the access level (e.g., change the role) of a particular user. For instance, if a guardian decides that a certain staff member should not have access to certain information, that guardian can lower the staff member to the role of other team member. Accordingly, guardian can allow the staff member to continue helping the individual, as another team member, without having access to all of the information of a staff member.

In addition to the aforementioned features, the online support system may comprise any other suitable feature. For example, the support system may comprise a chat-room environment, a settings feature that allows users to modify settings, a contact us feature, a tell-a-friend feature, an administrative control features, or the like.

The described systems and methods may also be modified in any suitable manner that allows the systems to provide an online support system devoted to helping an individual improve from a current level of functioning to a higher level of function. For example, the systems may be modified to allow a user to have any suitable level of control over who is able to access and/or interact with content posted, owned, or otherwise controlled by that particular user. In some embodiments, for instance, the ability of a user to select which team member(s) and/or role(s) are able to access specific content posted by the user is limited to content the user posts in the message center. In other embodiments, however, the ability for a user to control access to information posted by that user is available for use with any other suitable feature provided on the support system.

In one previously mentioned example, the ability to control access to a user's posted information is available in the my library feature. For instance, in the my library feature, a guardian may choose to post information that is only accessible to other guardians, staff, and/or administrators.

In another example, a user selects who (e.g., which user, role, etc.) is able access a specific piece of information posted on the instant information feature, the update feature, the upcoming events feature, and so forth. For instance, a staff member who wishes to inform an Individual's parents of an upcoming drug test on the individual, without the individual knowing of the test, can set the upcoming events feature to notify users having the role of guardian while preventing users having a different user role from being able to access such information.

As another example of how the described systems and methods may be modified, the types of information that are accessible to a user with a specific role may be varied in any suitable manner. For instance, a guardian (or other appropriate team member, such as an administrator) can increase or decrease the amount of information and/or sensitivity level of information that a user with a specific role can access or otherwise interact with over the support system. In other words, any given role may be given access to, or be prevented from accessing or otherwise interacting with, a specific type of information. In one possible example, while a user with the role of guardian is allowed to edit information within the my tasks feature, the calendar feature, the my library feature, and/or one or more other features, users with the status of “other team member” are not able to edit those features. In another possible example, while guardians and the individual are able to access a family photo sub-gallery in the photo gallery, the same photos not accessible to staff members. In still another example, while an administrator is able to access sensitive information (i.e., confidential information) for all individuals within a program, a staff member is only able to access sensitive information regarding individuals to which the staff member has been assigned by an administrator. This allows information to be freely and easily disseminated in certain channels while allowing users to be confident that specific information is not accessible to specific users.

In still another example of how the described methods can be modified, in some embodiments, the support system is modified to comprise an information-sharing tracking tool that makes a record of which content was accessed by which user. This tracking tool may serve many purposes, including retaining a record of who accessed sensitive information for purposes of HIPPA. Where the support system comprises the tracking tool, the system can track virtually any data relating to virtually any information (or content) that was accessed and/or interacted with (e.g., edited) by a user. For instance, the tracking tool may be used to track data associated with sensitive information, such as medical records, mental health records, assessment records, drug-test records, academic reports, clinical records, and other information that the guardian, family, group, organization, government, and the like deems sensitive.

The tracking tool is also capable of tracking virtually any data related to sensitive information. In one example, the tracking tool is capable of tracking which users have access to and/or actually access specific information (e.g., sensitive information). In other example, the tracking tool tracks when the information was accessed, how long the information was accessed, where the information was accessed, what was done with the information, and/or any other suitable data associated with the access of sensitive information.

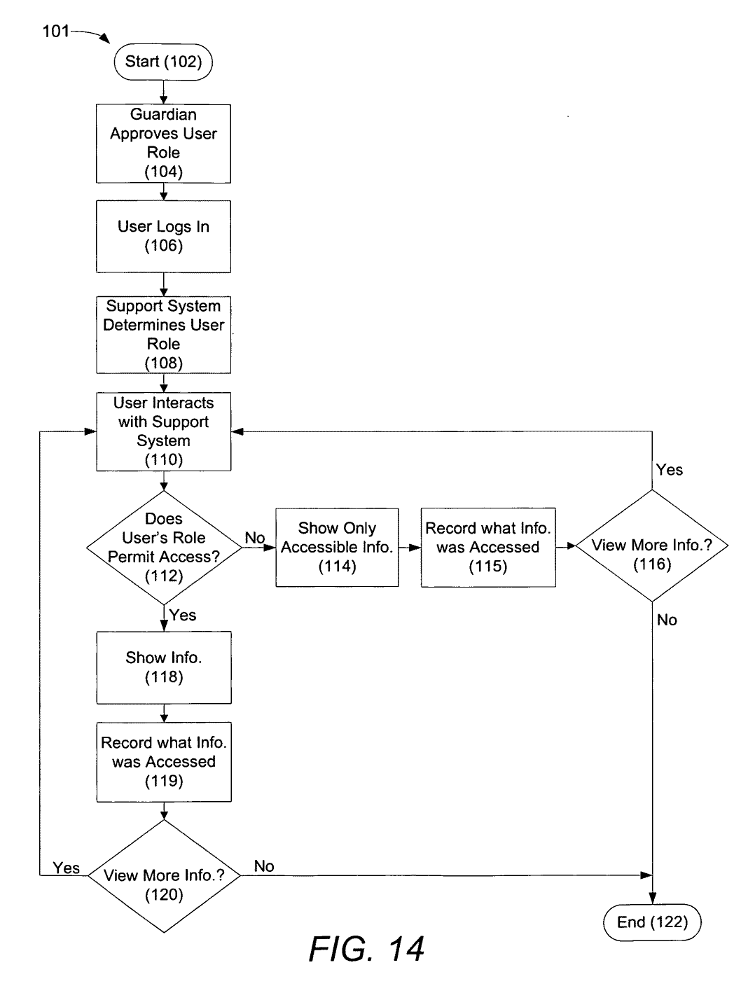

The tracking tool may track data relating to the access of sensitive information in any suitable manner. By way of example, FIG. 14 illustrates a flowchart depicting an example of a method very similar to that of FIG. 3. Nevertheless, the flowchart of FIG. 14 further shows one example of how the online support system tracks who accessed sensitive information. In particular, FIG. 14 shows that after starting at box 102, the method 101 continues to box 104, where the individual's legal guardian (or the individual, if a legal adult) approves a user's role.

At box 106, FIG. 14 shows the method continues as the user/team member logs onto the online support system. As the team member logs in, box 108 shows the support system determines the user's role (e.g., legal guardian, staff member, other team member, administrator, etc.). Next, box 110 shows the team member is allowed to interact with the support system in any suitable manner.

As the team member interacts with the system, box 112 shows that the system determines whether the team member's role allows that team member to have access to certain sensitive information, to edit certain information, or to otherwise interact with the system in a certain way. If the member's role does not permit a certain interaction, such as access to certain sensitive information, box 114 shows the support system only displays information that is not restricted to users with that team member's role. Additionally, box 115 shows that the support system records which information was displayed and which user accessed the information. While this recording may be done in any suitable manner, in some instances, the system annotates the team member's name and the file name of the accessed information.

After viewing the information, box 116 shows the team member is allowed view more information or otherwise interact with the system by returning to box 110. In the alternative, FIG. 14 shows that if the member chooses not to view additional information, the member's session ends at 122.

Returning to box 112, if the system determines the member's role permits access to certain sensitive information (or another interaction), box 118 shows that the system allows that member to access such information. Moreover, box 119 shows that the online support system records what information was accessed and which user(s) accessed the information.

Following this interaction, the member decides whether to continue interacting with the system (e.g., viewing additional content), as shown at 120. If the member chooses to continue interacting with the system, FIG. 14 shows the method returns to box 110. In the alternative, FIG. 14 shows that if the member chooses to stop interacting with the system, the method ends at 122.

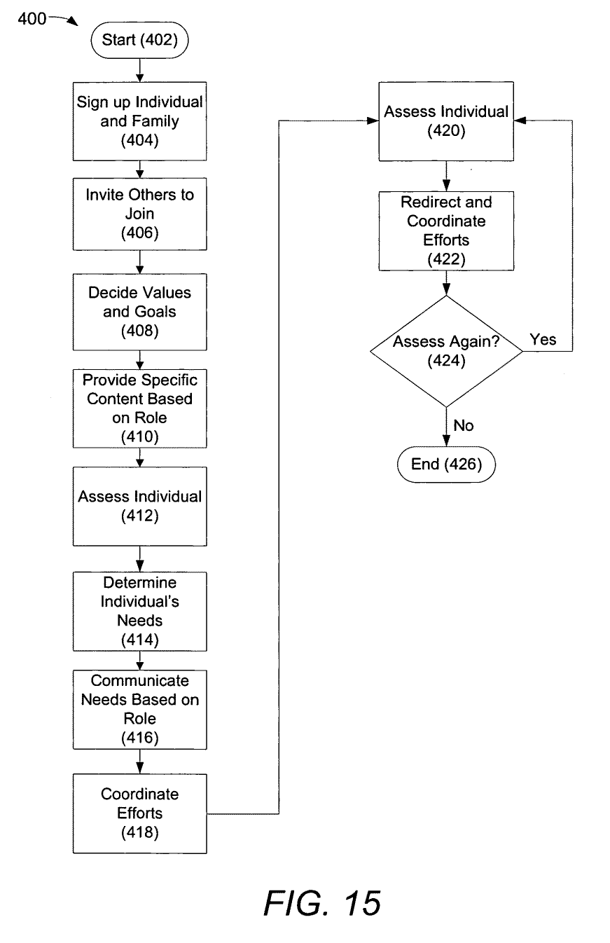

In order to provide a better understanding of the described systems and methods, FIG. 15 provides an example showing a flowchart of a method of how a family may use the describes system to help their teen transition from a drug-rehabilitation center. Specifically, FIG. 15 shows that after the method 400 begins at 402, the method continues at 404 as the family and individual signup to become users of the online support system. Box 406 shows the method continues as the family and individual invite others to join the home team. As invitees join the team, the parents approve each invitee for a specific role, with an accompanying level of access to various types of information. As mentioned, the information that may be accessed by each role may be decided in any suitable manner or by any suitable person.

Next, box 408 shows the individual and family can decide on values and goals and post those for other home members to see. Additionally, box 410 shows the online support system provides one or more users with library content that is both role specific and specific to the needs of the individual. In one example, the support system provides the parents with lessons on how to help a teen transition home from a drug-rehabilitation center. In this example, the support system also provides the teen's siblings with information on how to show support to a sibling transitioning from a rehabilitation center.

Box 412 shows the method continues by assessing the status of the individual and/or other home team members. For instance, the assessment may include providing the teen with a drug test. After the assessment, box 414 shows the system and/or team members may use the assessment to determine the needs of the teen. For instance, if the teen tested positive for drugs, the system may determine that the teen needs to be watched more closely. Box 416 shows that through the support system, the teen's needs are communicated to specific key team members, without being sent to all team members.

Box 418 shows the system is then used to further coordinate the efforts of the team members so as to help the teen overcome the teen's specific problem. In one example, the system automatically updates the library for specific users or users with specific roles. For instance, the library can be populated with information on how to watch your teen without aggravating the teen. In another example, staff members and parents may communicate concerns over the online support system and make sure that each team member is providing the type of support the teen needs.

Box 420 shows the method continues and the teen and/or the other team members are reassessed. Depending on the specific results of the assessment, box 422 shows the system may be used to redirect team member's efforts to focus on the teen's needs that have become apparent through the assessment. Decision box 424 further shows that this method may continue and the teen may be reassessed by returning to box 420. This method may be repeated and the efforts of the team member may be redirected again and again, as needed, until the method stops at 426.

The described systems and methods may offer several beneficial and advantageous characteristics that make the system especially well suited for allowing a plurality of users to communicate sensitive information and coordinated their efforts to help an individual (i.e., the individual, the individual's family, the individual's group, etc.) In one example, the support system allows sensitive information to be easily shared in a manner that prevents sensitive (i.e., confidential) information from being accessed by unintended or unapproved users. Accordingly, the described systems allow important information to be shared with one or many key individuals in a convenient manner.

In another example, the described systems and methods allow individuals to improve themselves and/or their family/support group through the integration of “self-help tools” and processes that coordinate and facilitate the support of people who can help the individual. Indeed, the online support system allows the individual and others to obtain specific and dynamic training on how to help the individual and other users obtain specific goals.

In another example, the described systems provide a centralized forum that focuses many people on the interest of the individual. Through this forum, programs and people, such as professionals, family members, friends, ecclesiastical leaders, and so forth can be brought together to communicate about and with the individual in an effective and efficient manner.

In another example, by assessing the individual, the described systems and methods provide feedback about the individual's progress. This information is used to help direct the efforts of the individual as well as to allow other team members to customize their support for the specific needs of the individual.

In still another example, because the support system is easy to understand and simple to use, the support system may be implemented by a family and/or other home team members, independent of an organization or program. For instance, a family in which the father is trying to recover from alcohol abuse can voluntarily become users of the support system and invite other key individuals to join the system to help their father and family through the transition.

The present invention may be embodied in other specific forms without departing from its spirit or essential characteristics. Each of the described embodiments and examples are to be considered in all respects as illustrative only and not as being restrictive in any manner. The scope of the invention is, therefore, indicated by the appended claims rather than by the foregoing description. All changes that come within the meaning and range of equivalency of the claims are to be embraced within their scope.

What is claimed is:

1. in an electronic system configured to enable collaboration within a controlled: support group, a method for providing focused online support for an individual, the method comprising:
establishing a dynamic, online, and collaborative support system, wherein the support system focuses on helping an individual maintain or improve from a current level of function to a higher level of function;
providing a plurality of users with access to information provided on the online support system; and
providing at least a portion of the information to a specific user, based upon a role assigned to the specific user.

2. The method of claim 1, wherein the role of the specific user is selected from a plurality of roles with differing access levels and wherein the role of the specific user is approved by a legal guardian of the individual.

3. The method of claim 1, wherein the specific user is able to post content on the online support system and to restrict who is able to view the content.

4. The method of claim 1, wherein the online support system provides professionals with a conduit to confidentially collaborate efforts to help the individual.

5. The method of claim 1, further comprising tracking which information is accessed and which user accessed the information.

6. The method of claim 1, further comprising assessing a progress status of the individual.

7. The method of claim 2, further comprising providing the legal guardian with a mechanism to banish the specific user from the support system.

8. The method of claim 6, further comprising coordinating efforts among the plurality of users to help the individual based upon results from the assessing of the individual's progress status.

9. A computer program product for implementing within a computer system a method for supporting an individual, the computer program product comprising:
a computer readable medium for providing computer program code means utilized to implement the method, wherein the computer program code means is comprised of executable code for:
establishing a dynamic, online, and collaborative support system, wherein the support system focuses on helping an individual maintain or improve from a current level of function to a higher level of function;
providing a plurality of users with access to information provided on the online support system; and
providing at least a portion of the information to a specific user, based upon a role assigned to the specific user.

10. The computer program product of claim 9, wherein the computer program code means is further comprised of executable code for providing a role-based-confidential-communications conduit.

11. The computer program product of claim 9, wherein the computer program code means is further comprised of executable code for allowing a legal guardian of the individual to approve the role assigned to the specific user.

12. The computer program product of claim 9, wherein the computer program code means is further comprised of executable code for allowing the specific user to post content on the online support system and to restrict who is able to view the content.

13. The computer program product of claim 9, wherein the computer program code means is further comprised of executable code for tracking which information is accessed and which user accessed the information.

14. The computer program product of claim 11, wherein the computer program code means is further comprised of executable code for providing the legal guardian with a mechanism to banish the specific user from the support system.

15. The computer program product of claim 9, wherein the computer program code means is further comprised of executable code for assessing a progress status of the individual and generating a report of the progress status.

16. A computer program product for implementing within a computer system a method for supporting an individual, the computer program product comprising:
a computer readable medium for providing computer program code means utilized to implement the method, wherein the computer program code means is comprised of executable code for implementing:
establishing a dynamic, online, and collaborative support system, wherein the support system focuses on helping an individual maintain or improve from a current level of function to a higher level of function;
providing a plurality of users with access to information provided on the online support system, wherein each user is assigned a specific role selected from a plurality of roles; and
providing at least a portion of the information to a specific user, based the user's specific role, wherein the specific role is approved by a legal guardian of the individual.

17. The computer program product of claim 16, wherein the specific user is able to post content on the online support system and to restrict who is able to view the content.

18. The computer program product of claim 16, wherein the computer program code means is further comprised of executable code for allowing the specific user to post content on the online support system and to restrict who is able to view the content.

19. The computer program product of claim 16, wherein the computer program code means is further comprised of executable code for tracking which information is accessed and which user accessed the information.

20. The computer program product of claim 16, wherein the computer program code means is further comprised of executable code for providing the legal guardian with a mechanism to banish the specific user from the support system.
